(19) United States
(12) Patent Application Publication
(10) Pub. No.: US 2026/0175183 A1
(43) Pub. Date: Jun. 25, 2026

(54) SMOOTHIE MAKER

(71) Applicant: Disheng Huang, Foshan (CN)

(72) Inventor: Disheng Huang, Foshan (CN)

(21) Appl. No.: 19/537,337

(22) Filed: Feb. 11, 2026

(30) Foreign Application Priority Data
Nov. 17, 2025 (CN) 202522432828.0
Nov. 17, 2025 (CN) 202522433182.8
Dec. 30, 2025 (CN) 202522799820.8
Dec. 30, 2025 (CN) 202522810540.2
Dec. 30, 2025 (CN) 202522812935.6
Dec. 30, 2025 (CN) 202522813105.5

(51) Int. Cl. B01F 27/1123; A47J 43/07

(52) U.S. Cl. CPC B01F 27/1123; A47J 43/0727

(57) ABSTRACT

Provided is a smoothie maker including a casing, a refrigeration unit, a stirring unit, and a material barrel detachably mounted on the casing, the refrigeration unit having an evaporator; further including an evaporator mounting chamber, and the evaporator fitting on the inner wall of the evaporator mounting chamber, and the evaporator mounting chamber fitting into the material barrel, and the stirring unit having a rotating shaft, and a stirring blade unit, wherein a head end of the rotating shaft passes through the evaporator mounting chamber and connects the stirring blade unit in a driving manner, the stirring blade unit fits on an outer wall of the evaporator mounting chamber, and a shaft mounting seat for supporting the rotating shaft is disposed on the evaporator mounting chamber. The smoothie maker has a reasonable structure and advantages such as easy cleaning and replacement.

### CROSS-REFERENCE TO RELATED APPLICATIONS

This application claims priority to Chinese Patent Application No. 202522432828.0, filed on Nov. 17, 2025, Application No. 202522433182.8, filed on Nov. 17, 2025, Application No. 202522799820.8, filed on Dec. 30, 2025, Application No. 202522810540.2, filed on Dec. 30, 2025, Application No. 202522812935.6, filed on Dec. 30, 2025, and application No. 202522813105.5, filed on Dec. 30, 2025, all of which are hereby incorporated by reference in their entireties.

### TECHNICAL FIELD

The present invention relates to the technical field of refrigeration equipment, in particular to a smoothie maker.

### BACKGROUND

A smoothie maker is a device that provides low-temperature and semi-frozen fruit beverages, which is classified into a household model and a business model. The current household-type smoothie maker is generally composed of a casing, a refrigeration unit, a storage container and a stirring system. The storage container has an inlet and an outlet arranged on itself, and stirring blades installed inside itself. When the refrigeration unit is operating, an evaporator cools a beverage to make it freeze in the storage container, meanwhile the beverage is stirred by a stirring means, so as not to form ice chunks, gradually turning into a smoothie. The evaporator has a cylindrical shell from which a stirring shaft extends to connect the stirring blades, so it is necessary for the stirring shaft to have a sealing element mounted in its bearing unit, so as to prevent liquid leakage. However, the current smoothie maker has a stirring shaft with a non-removable sealing ring, which cannot be replaced once it ages.

### SUMMARY

The technical problem to be solved by the present invention is to provide a smoothie maker, which has advantages of handily cleaning a material barrel and easily replacing a shaft seal, so as to overcome the shortcomings of the prior art.

In order to solve the above technical problem, the present invention provides a technical solution as follows. A smoothie maker includes a casing, a refrigeration unit, a stirring unit, a controller, and a material barrel detachably mounted on the casing, and the refrigeration unit having a compressor, an evaporator, a condenser and a throttling device, including an evaporator mounting chamber, and the evaporator fitting on an inner wall of the evaporator mounting chamber, and the evaporator mounting chamber fitting into the material barrel, and the stirring unit having a stirring motor, a rotating shaft, and a stirring blade unit; wherein a head end of the rotating shaft passes through the evaporator mounting chamber and connects the stirring blade unit in a driving manner, the stirring blade unit fits on an outer wall of the evaporator mounting chamber, and a shaft mounting seat for supporting the rotating shaft is disposed on the evaporator mounting chamber, and the shaft mounting seat includes a fixing disk, a shaft seal, and a base, and the base is disposed inside the evaporator mounting chamber, and the fixing disk and the shaft seal both outside the evaporator mounting chamber are detachably fixed to the base.

In a non-operational state, it is possible to detach the material barrel from the casing to clean the interior of the material barrel. Since the fixing disk and the shaft seal have been installed both outside the evaporator mounting chamber, in the case that the shaft seal becomes aged or damaged, it is possible to detach and replace it after removing the material barrel, thereby preventing juice from leaking due to poor sealing.

Furthermore, the front wall of the material barrel disclosed herein has a convex cavity near a liquid outlet, and the front end of the stirring blade unit is close to a main panel of the convex cavity; thus, by way of using a sloped upper side wall to guide a smoothie back toward the rear of the material barrel, it is possible to prevent the smoothie from accumulating and forming clumps at the front end of the material barrel and make the smoothie finer.

Furthermore, by way of connecting a first assembly ring of a barrel mounting seat with a second assembly ring of a barrel assembly plate by means of rotational catches, it is possible to position, install and detach the material barrel very easily.

Furthermore, by way of setting a sealing structure between the first assembly ring and the second assembly ring, and between the first assembly ring and the evaporator mounting chamber, it is possible to ensure that the smoothie does not leak. A condensation water collecting part is arranged below the material barrel to collect the condensation water formed on the outer wall of the material barrel during atmospheric condensation caused by a low-temperature smoothie, and drain the condensation water through a water guide hole.

Furthermore, a feeding seat and a splash guard are installed at a notch on the top wall of the material barrel, and the splash guard runs in a direction the same as the direction for stirring; thus, it is possible to prevent the smoothie from splashing out of the notch. A switch of the liquid outlet includes two parts, simplifying a switch structure and making it more favorable to manufacture products and reduce costs.

### BRIEF DESCRIPTION OF THE DRAWINGS

FIG. 1 is a three-dimensional view of the smoothie maker of the present invention.

FIG. 2 is a cross-sectional view of the smoothie maker.

FIG. 3 is a sectional view of the evaporator mounting chamber.

FIG. 4 is an exploded view of the shaft mounting seat.

FIG. 5 is a sectional view of the material barrel and the discharge valve switch.

FIG. 6 is an exploded view of the material barrel shown in FIG. 5;

FIG. 7 is a diagram of a rotationally catching unit for the material barrel.

FIG. 8 is an exploded view of the handle.

FIG. 9 is a cross-sectional view of the handle.

FIG. 10 is a structure diagram of the barrel mounting seat.

FIG. 11 is a sectional view of the material barrel.

FIG. 12 is a structure diagram of the condensation water collecting part.

FIG. 13 is a longitudinal sectional view of the smoothie maker.

FIG. 14 is a partially enlarged view of the sealing connection structure between the material barrel and the barrel mounting seat.

### DESCRIPTION OF EMBODIMENTS

The specific embodiment of the present invention will be further described below in combination with the figures.

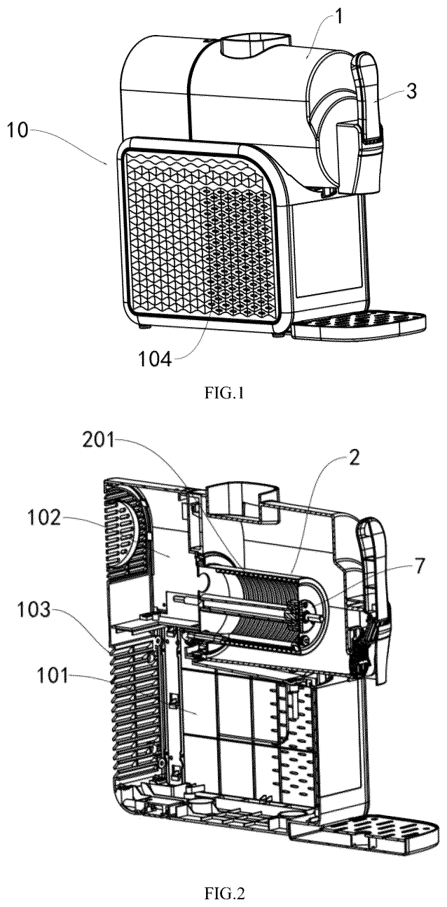

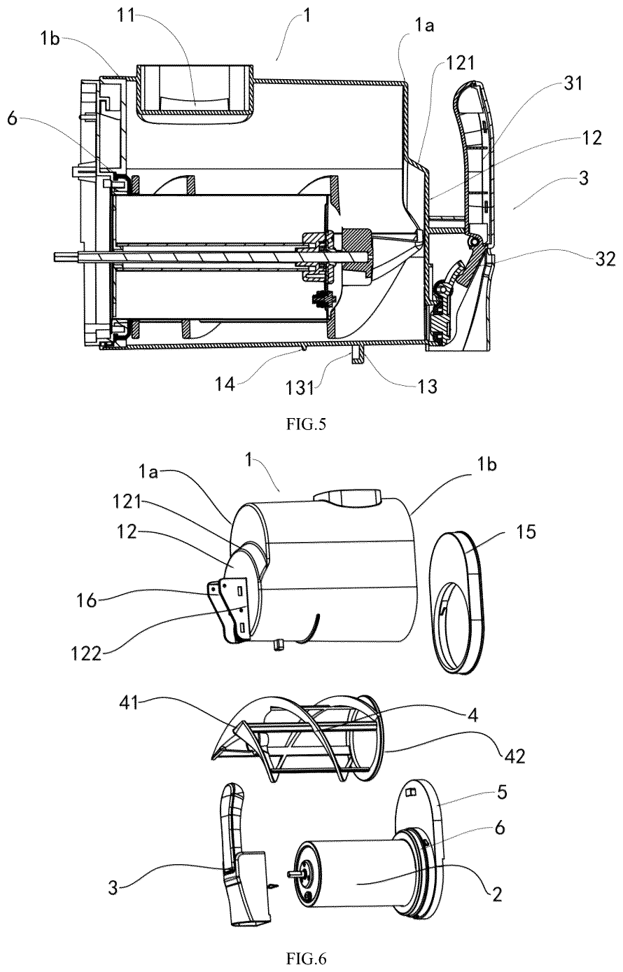

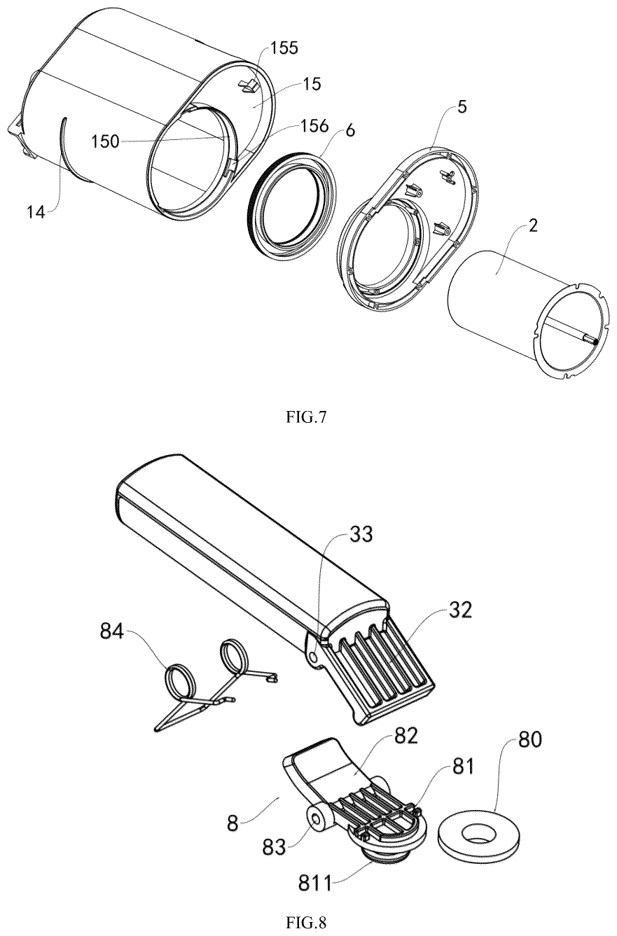

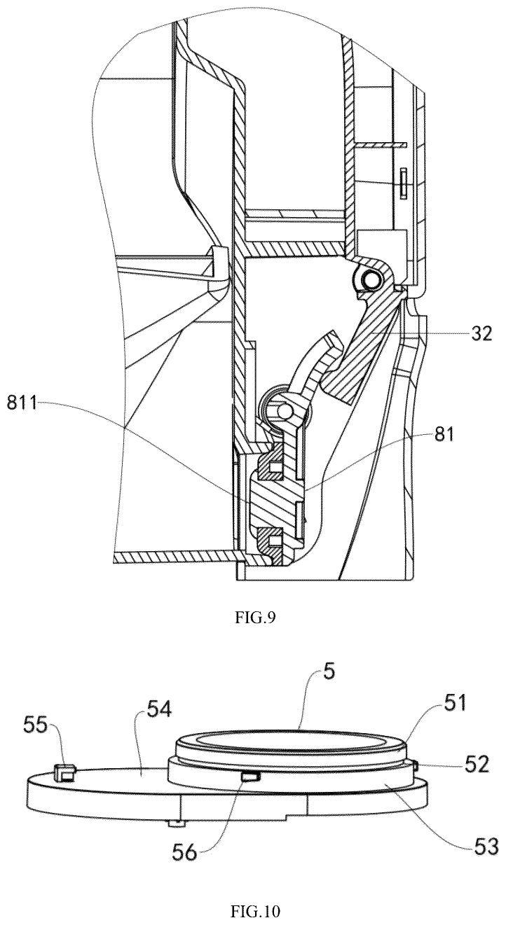

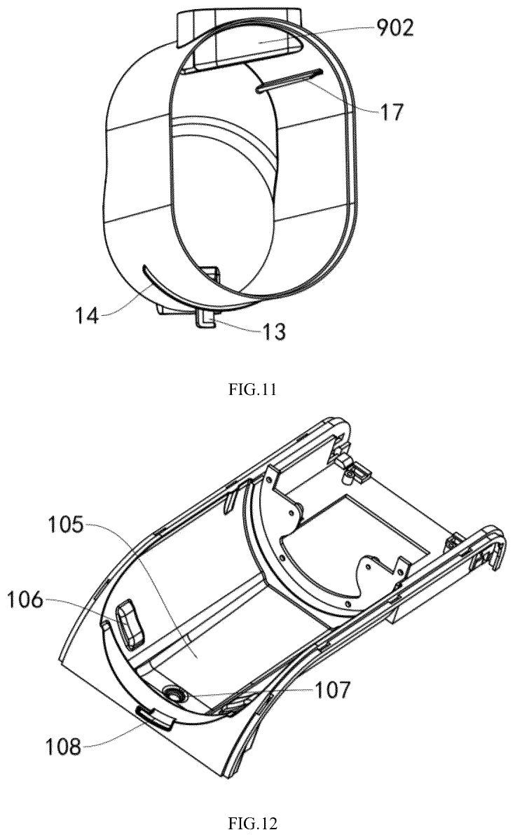

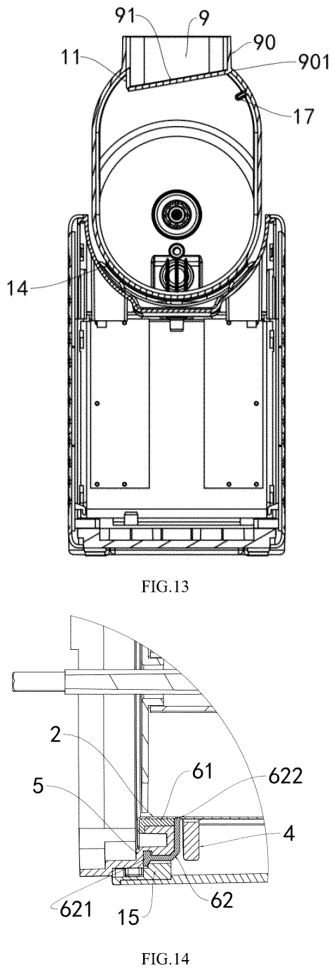

As shown in FIGS. 1-14, a smoothie maker includes a casing, a refrigeration unit, a stirring unit, a controller, and a material barrel 1 detachably mounted on the casing. The refrigeration unit has a compressor, an evaporator 201, a condenser and a throttling device. The stirring unit has a stirring motor, a rotating shaft, and a stirring blade unit 4. The casing is divided into a upper part and a lower part. The compressor and the condenser are disposed in the lower cavity 101 of the casing (not shown in the figure). A stirring motor and a motor cooling fan are disposed in the upper cavity 102 of the casing. The material barrel 1 is arranged above the lower cavity 101, and the rear portion of the material barrel 1 is close to the upper cavity 102. A ventilation grille is arranged on both the upper and lower parts of the rear panel 103 of the casing, and these ventilation grilles fit with ventilation openings 104 on two side panels of the casing to form a heat dissipation airflow system for the compressor, the condenser, and the stirring motor. The smoothie maker further includes an evaporator mounting chamber 2. The evaporator fits on the inner wall of the evaporator mounting chamber, and the evaporator mounting chamber fit into the material barrel. A head end of the rotating shaft passes through the evaporator mounting chamber and connects the stirring blade unit in a driving manner. The stirring blade unit fits on an outer wall of the evaporator mounting chamber. A shaft mounting seat 7 for supporting the rotating shaft is disposed on the evaporator mounting chamber. The shaft mounting seat includes a fixing disk 71, a shaft seal 72, and a base 73, and the base is disposed inside the evaporator mounting chamber, and the fixing disk and the shaft seal both outside the evaporator mounting chamber are detachably fixed to the base.

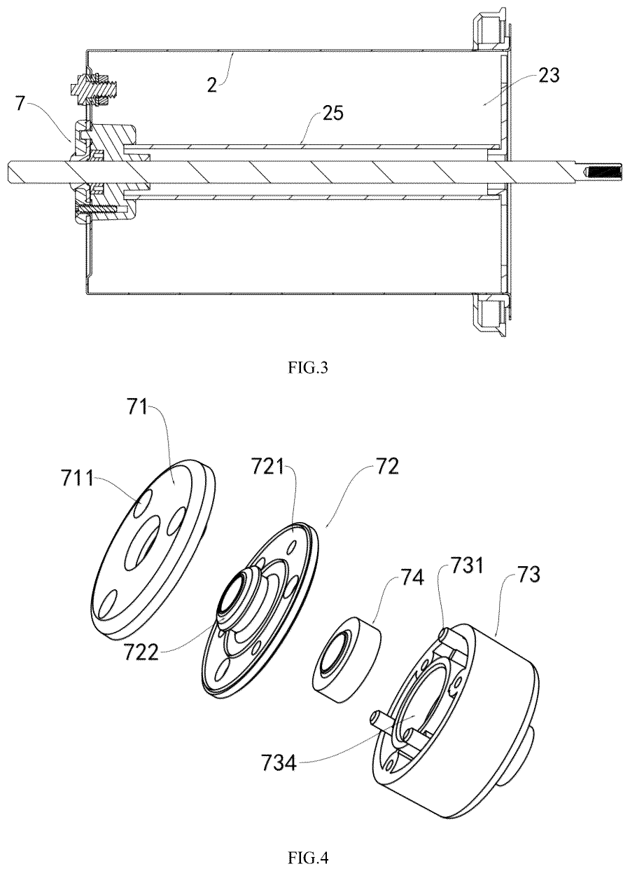

The lower part of the front wall of the material barrel 1 protrudes outward to form a convex cavity 12. A main panel of the convex cavity has a discharge outlet, and a discharge valve switch 3 is set on the discharge outlet. The front end of the stirring blade unit 4 is close to the main panel of the convex cavity. An upper side wall of the convex cavity has a slope 121. A first through hole 711 is set on the fixing disk, and a second through hole is set on the shaft seal, and a mounting post is set inside the base, and a third mounting hole 731 is set inside the mounting post, and a fastener passes through the first through hole, the second through hole, and the third mounting hole, so as to fixedly connect the fixing disk, the shaft seal, and the base. The shaft seal 72 has a piece body 721 and a shaft sleeve portion 722, and the shaft sleeve portion passes through a central hole of the fixing disk. Both the fixing disk land the base are made of plastic, and the fastener may be a screw. An oil seal installation cavity 734 is set inside the base, and an oil seal 74 is disposed inside the oil seal installation cavity 734. One end of the rotating shaft of the stirring unit is driven by a motor, while the other end passes through the shaft hole of the oil seal, the shaft seal and the fixing disk, protrudes from the front of the evaporator mounting chamber, and connects the stirring blade unit, thereby driving it to rotate. When the stirring blade unit rotates, it not only scrapes the smoothie off the surface of the evaporator mounting chamber but also pushes the smoothie toward the discharge outlet of the material barrel. The inner wall of the chamber wall of the evaporator mounting chamber 2 clings to the evaporator, thereby lowering the temperature of the chamber wall and cooling the juice inside the material barrel through the chamber wall. As shown in FIG. 3, a sleeve 25 is disposed inside the evaporator mounting chamber 2. One end of the sleeve 25 is fixed to the base 73. After installing the base 73 and the sleeve 25, a foaming agent is injected into the inner chamber of the evaporator mounting chamber 2 to form a foam layer 23. Since the sleeve is a hollow tube, the rotating shaft can pass through the sleeve 25 throughout the entire evaporator mounting chamber 2.

A barrel mounting seat 5 is disposed on the casing. The barrel mounting seat includes a bottom plate 54 and a first assembly ring set on the bottom plate 54 by hollowing out. The evaporator mounting chamber 2 passes through the first assembly ring. One end of the material barrel has a barrel assembly plate 15. The barrel assembly plate 15 and the material barrel body can be formed through ultrasonic welding. A second assembly ring 150 is set on the barrel assembly plate by hollowing out. The first assembly ring and the second assembly ring are connected with each other through a rotational catch between their walls. The first assembly ring includes a first ring opening portion 51 and a first ring root portion 53, and a seal groove 52 is set between the first ring opening portion 51 and the first ring root portion 53. A barrel sealing ring 6 wraps around both opposing sides of the first ring opening portion. The first ring root portion 53 has a positioning block 56, and a barrel slot 156 is set on the second assembly ring 150. The barrel slot is L-shaped, including a first slot and a second slot both connected to each other. The positioning block 56 enters the second slot from an opening of the first slot to achieve a catching connection. A positioning protrusion is set on the positioning block 56, and a concave portion corresponding to this positioning protrusion is set on the second slot. This design requires hands to apply a force for installing the material barrel. When a catch unit is in place, the positioning protrusion is embedded in the concave portion. When it is necessary to detach the material barrel from the casing, in the same way that a force is needed to be applied, only if the positioning protrusion is disengaged from the concave portion, it can get away from the second slot. The barrel sealing ring 6 includes an inner sealing ring 61 and an outer sealing piece 62. The inner sealing ring 61 is clamped between the first assembly ring and the evaporator mounting chamber, while the outer sealing piece 62 is clamped between the first assembly ring and the second assembly ring. The outer sealing piece 62 is L-shaped, and one end of the L-shaped sealing piece has a rim 622, which presses against an outer wall of the evaporator mounting chamber 2. The other end of the L-shaped sealing piece has a mounting head 621, one end of which is embedded in the seal groove 52, and the other end of which is embedded in a gap formed between the second assembly ring 150 and the first ring root portion 53.

The casing has a condensation water collecting part 105, and a water guide hole 107 is set on the condensation water collecting part 105. The water guide hole is used to guide condensation water on the outer wall of the material barrel to a water receiving tray inside the casing or discharge it out of the casing. The inner wall of the material barrel has a material blocking rib plate 17, which is used to prevent the material inside the material barrel from rising along a barrel wall when the stirring blade unit rotates. A supporting protrusion 106 is set on a side wall of the casing connected to the condensation water collecting part, and a third slot 108 with an upper opening is set on the front wall of the casing connected to the condensation water collecting part. The outer wall of the material barrel has a barrel catching hook 13 and an arc-shaped rib 14; the barrel catching hook engages with the third slot, and the arc-shaped rib 14 stands on the supporting protrusion 106. The barrel catching hook 13 is L-shaped and has a baffle 131. During installing the material barrel, the second assembly ring 150 fits into the evaporator mounting chamber until it is close to the barrel mounting seat 5. At this time, the barrel catching hook 13 lies at the opening of the third slot 108, the material barrel is held by hand to make the barrel catching hook 13 enter from the opening of the L-shaped third slot, when the barrel catching hook 13 touches the limit of the third slot, it rotates into position. A fourth catching hook 55 is disposed on the bottom plate 54, and an assembly plate catching hook 155 is disposed on the barrel assembly plate 15. Both the fourth catching hook 55 and the assembly plate catching hook 155 have a L-shaped hook. The structure of the fourth catching hook 55 is the same as that of the barrel catching hook 13, and the fourth catching hook 55 also has a baffle. Therefore, when the material barrel is twist-mounted onto the barrel mounting seat 5, the fourth catching hook 55 and the assembly plate catching hook 155 engage with each other and form a limiting structure, thereby allowing the material barrel to rotate into position.

The top wall of the material barrel has a notch, which is approximately square in shape. A vertical wall 90 extends along an edge of the notch to form a feeding seat 9, and a cover is set at the top of the feeding seat (not shown in the figure). The vertical wall 90 has a pair of inner walls 902 inside the material barrel. The bottom of the feeding seat 9 has a splash guard 91 disposed on the notch. A first side of the splash guard connects to a root portion 901 of the feeding seat, while a second side of the splash guard slopes downward and does not connect the vertical wall 90. The left and right sides of the splash guard connect the inner walls 902, thereby forming a side feeding port 11 below the feeding seat. The second side is opposite the first side, and the splash guard from the first side to the second side runs in a direction the same as the direction in which the stirring blade unit drives the material inside the material barrel to rotate.

As shown in FIG. 5, a convex cavity 12 is set on the lower part of the front wall 1a of the material barrel. The upper side wall 121 of the convex cavity 12 has a slope, and a discharge outlet is set on the main panel 122 of the convex cavity 12. A switch seat 16 is disposed on the main panel 122, and the discharge valve switch 3 is mounted on the switch seat 16. During use, the handle 31 is toggled to actuate the discharge valve switch 3 to open the discharge outlet. When the smoothie maker operates, the beverage liquid is added into the material barrel 1 through the feeding inlet, and under cooling and stirring, it is made into a smoothie, which is discharged from the discharge outlet. The discharge valve switch includes a handle and a sealing cover 8. The handle is divided from both sides of a hinge hole 33 of the handle into a toggled handle part 31 and a connecting wall 32. A hinge pin passes through the hinge hole 33 to mount the handle on the switch seat 16. The sealing cover includes a cover plate, a sealing gasket 80, and a reset torsion spring 84. The cover plate is divided from both sides of a hinge hole 83 of the cover plate into a first end and a second end. A free end of the connecting wall 32 presses against the first end 82 of the cover plate. The sealing gasket is installed on the second end 81 of the cover plate. The reset torsion spring respectively lies against the second end 81 of the cover plate and the front wall 122 of the material barrel, so that the reset torsion spring has potential energy that actuates the second end of the cover plate to close the liquid outlet. Referring to FIG. 9, when the toggled handle part is pulled outward, the connecting wall 32 applies pressure to the first end of the cover plate, so as to cause the cover plate to rotate and the sealing gasket 80 to move away from the discharge outlet, thereby opening the discharge outlet. A sealing gasket seat 811 is disposed on the second end 81 of the cover plate, and the sealing gasket 80 is mounted on the sealing gasket seat. Referring to FIG. 9, the first end 82 of the cover plate is curved outward, and a rim is set on the surface of the connecting wall 32 that contacts the first end of the cover plate, so as to apply a less force to toggle the handle.

The upper side wall 121 of the convex cavity 12 uses its own slope to guide the smoothie that is not discharged in time from the discharge outlet to move toward the rear end 1b of the material barrel, so as to prevent the smoothie from accumulating and clump together above the front wall 1a of the material barrel, thereby reducing the pressure on the front wall 1a of the material barrel. The top of the material barrel 1 has an arched structure. The rear end 1b of the material barrel is arranged opposite the front wall 1a of the material barrel. The projected area of the front wall 1a is slightly smaller than that of the rear end 1b. The material barrel tapers slightly from the rear end 1b to the front wall 1a, forming a shape that narrows toward the discharge outlet. The stirring blade unit 4 has a pushing head 41 opposite a bottom seat 42. When the evaporator is mounted onto the material barrel 1, the pushing head 41 of the stirring blade 4 enters the convex cavity 12 and touches the discharge outlet. During operation, the stirring blade unit 4 rotates, so that the pushing head 41 pushes the smoothie out through the discharge outlet.

A detailed description to the embodiments of the invention has been made above in combination with the figures. For a person skilled in the art, any changes, modifications, substitutions, and variations made to these embodiments, without departing from the principles of the invention, still fall within the protection scope of the present invention.

What is claimed is:

1. A smoothie maker, comprising: a casing, a refrigeration unit, a stirring unit, a controller, and a material barrel detachably mounted on the casing; the refrigeration unit having a compressor, an evaporator, a condenser and a throttling device, further comprising: an evaporator mounting chamber, and the evaporator fitting on an inner wall of the evaporator mounting chamber, and the evaporator mounting chamber fitting into the material barrel, and the stirring unit having a stirring motor, a rotating shaft, and a stirring blade unit;
wherein a head end of the rotating shaft passes through the evaporator mounting chamber and connects the stirring blade unit in a driving manner, the stirring blade unit fits on an outer wall of the evaporator mounting chamber, and a shaft mounting seat for supporting the rotating shaft is disposed on the evaporator mounting chamber, and the shaft mounting seat includes a fixing disk, a shaft seal, and a base, and the base is disposed inside the evaporator mounting chamber, and the fixing disk and the shaft seal both outside the evaporator mounting chamber are detachably fixed to the base.

2. The smoothie maker according to claim 1, wherein a lower part of a front wall of the material barrel protrudes outward to form a convex cavity, and a main panel of the convex cavity has a discharge outlet, and a discharge valve switch is set on the discharge outlet; the front end of the stirring blade unit is close to the main panel of the convex cavity; an upper side wall of the convex cavity has a slope.

3. The smoothie maker according to claim 1, wherein a first through hole is set on the fixing disk, and a second through hole is set on the shaft seal, and a third mounting hole is set on the base, and a fastener passes through the first through hole, the second through hole, and the third mounting hole, so as to fixedly connect the fixing disk, the shaft seal, and the base; the shaft seal has a piece body and a shaft sleeve portion, and the shaft sleeve portion passes through a central hole of the fixing disk.

4. The smoothie maker according to claim 1, wherein a barrel mounting seat is disposed on the casing, and the barrel mounting seat includes a bottom plate and a first assembly ring set on the bottom plate by hollowing out, and the evaporator mounting chamber passes through the first assembly ring, and the material barrel has a barrel assembly plate, and a second assembly ring is set on the barrel assembly plate by hollowing out, and the first assembly ring and the second assembly ring are connected with each other through a rotational catch between their walls.

5. The smoothie maker according to claim 4, wherein the first assembly ring includes a first ring opening portion and a first ring root portion, and a seal groove is set between the first ring opening portion and the first ring root portion, and a barrel sealing ring wraps around both opposing sides of the first ring opening portion, and the first ring root portion has a positioning block, and a barrel slot is set on the second assembly ring, and the barrel slot includes a first slot and a second slot both connected to each other, and the positioning block enters the second slot from an opening of the first slot to achieve a catching connection.

6. The smoothie maker according to claim 5, wherein the barrel sealing ring includes an inner sealing ring and an outer sealing piece, and the inner sealing ring is clamped between the first assembly ring and the evaporator mounting chamber, while the outer sealing piece is clamped between the first assembly ring and the second assembly ring; the outer sealing piece is L-shaped, and one end of the L-shaped sealing piece has a rim, which presses against an outer wall of the evaporator mounting chamber, and the other end of the L-shaped sealing piece has a mounting head, one end of which is embedded in the seal groove, and the other end of which is embedded in a gap formed between the second assembly ring and the first ring root portion.

7. The smoothie maker according to claim 1, wherein the casing has a condensation water collecting part, and a water guide hole is set on the condensation water collecting part, and the water guide hole is used to guide condensation water on the outer wall of the material barrel to a water receiving tray inside the casing or discharge it out of the casing, and the inner wall of the material barrel has a material blocking rib plate, which is used to prevent material inside the material barrel from rising along a barrel wall when the stirring blade unit rotates.

8. The smoothie maker according to claim 7, wherein a supporting protrusion is set on a side wall of the casing connected to the condensation water collecting part, and a third slot with an upper opening is set on the front wall of the casing connected to the condensation water collecting part, and the outer wall of the material barrel has a barrel catching hook and an arc-shaped rib; the barrel catching hook engages with the third slot, and the arc-shaped rib stands on the supporting protrusion.

9. The smoothie maker according to claim 1, wherein the top wall of the material barrel has a notch, and a vertical wall extends along an edge of the notch to form a feeding seat, and a splash guard is disposed on the notch, and a first side of the splash guard connects to a root portion of the feeding seat, while a second side of the splash guard slopes downward and does not connect the vertical wall, so as to form a side feeding port below the feeding seat, and the second side is opposite the first side, and the splash guard from the first side to the second side runs in a direction the same as the direction in which the stirring blade unit drives material inside the material barrel to rotate.

10. The smoothie maker according to claim 2, wherein the discharge valve switch includes a handle and a sealing cover, and the handle includes a toggled handle part and a connecting wall that are respectively positioned on both sides of a hinge hole, and the sealing cover includes a cover plate, a sealing gasket, and a reset torsion spring, and a free end of the connecting wall presses against a first end of the cover plate, and the sealing gasket is installed on a second end of the cover plate, and the reset torsion spring respectively lies against the second end of the cover plate and the front wall of the material barrel, so that the reset torsion spring has potential energy that actuates the second end of the cover plate to close a liquid outlet.
